(19) United States
(12) Patent Application Publication
(10) Pub. No.: US 2002/0092630 A1
(43) Pub. Date: Jul. 18, 2002

(54) Roller shade for a transparent vehicle roof section

(76) Inventors: Uwe Kremer, Korntal-Munchingen (DE); Alexander Turk, Ditzingen (DE); Dirk Helwich, Stuttgart (DE); Susanne Schandel, Commerce TWP, MI (US)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/051,809

(22) Filed: Jan. 11, 2002

(30) Foreign Application Priority Data
Jan. 12, 2001 (DE) 101 01 491.0

(51) Int. Cl. B60J 3/00

(52) U.S. Cl. 160/370.22

(57) ABSTRACT

In a support arrangement of roller shade for a transparent vehicle roof section which is disposed in an opening of a vehicle roof and is movable between a closed and an open position, a shade roller is rotatably supported by the roof element and a shade web is wound onto the shade roller and connected with its free end to a pull bar, the shade roller and the pull bar being both supported at the underside of the roof section so as to be movable relative to each other.

### BACKGROUND OF THE INVENTION

The invention relates to a roller shade for a transparent vehicle roof section which is disposed in an opening in the roof of a vehicle roof so as to be movable between a closed and an open position at the lower side of the vehicle roof section adjacent the vehicle interior.

DE 199 10 830 C1 discloses a roller shade arrangement, which is disposed adjustably at the underside of the roof between a shielding position and a closed position. In the closed position, the roller shade covers a transparent roof section, which is disposed in a roof opening of the vehicle. The roller shade arrangement includes a windup roller or to which a shade can be wound as well as a pull member, which is connected to the shade and which can be moved in the longitudinal direction of the vehicle for unwinding the shade frog, or winding it onto, the wind-up roller. As drive for the roller shade, a drive cable is provided, which is connected to the pull member for moving it between open and closed end positions. The wind-up roller is mounted on a rear vehicle roof frame member, which is disposed, in the longitudinal vehicle direction, behind the movable roof section. The drive cable, which engages the pull member is guided around a front bearing structure which is disposed in the area of the front edge of the roof element in a front roof frame member. In a closed (protective) position, the unwound shade extends between the rear and front roof frame members directly below the roof element disposed in the roof opening.

DE 197 01 682 C2 disclosed a vehicle roof, which can be opened, and which includes, adjacent the windshield frame of the vehicle, a wind deflector sheet which is pivotally supported at the front end thereof so as to be pivotable between a lowered and an upstanding position. The wind deflector sheet is supported at the lower side of an outer sheet part by a transverse beam which includes an area in which a roller shade is contained for covering, when unwound, the underside of a removable roof section disposed adjacent the wind deflector strip. Operation of the shade roller however is ensured only in the closed position of the movable roof section. When the movable roof section is an open position where the roller shade would extend over the open roof opening the roller shade would be exposed to the wind during driving.

It is the object of the present invention to provide in a vehicle roof with a roof opening including a transparent roof section a multi-purpose roller shade wherein wind and flutter noises of the shade are avoided when the shade is extended across the roof section.

### SUMMARY OF THE INVENTION

In a support arrangement of roller shade for a transparent vehicle roof element, which is disposed in an opening of a vehicle roof and is movable between a closed and an open position a shade roller is rotatably supported by the roof section and a shade web is wound onto the shade roller and connected, with its free end, to a pull bar, the shade roller and the pull bar being both supported at the underside of the roof section so as to be movable relative to each other.

Since the roller shade is supported exclusively on the movable roof section, it is moved together with the movable roof section so that it is moved—in open or closed position—out of the roof opening when the movable roof section is moved to its open position. A situation, in which the roof section is opened while the roller shade extends across the roof opening and is subjected to the wind forces, which may result in a destructive flutter, is therefore avoided.

Furthermore, with the arrangement, the roller shade can be moved between the closed shading position, in which it covers the transparent roof section, and the open position, in which the shade is wound onto the shade roller and the underside of the removable roof section is exposed independently of the momentary position of the movable roof section. The wind-up and unwind movement of the roller shade is completely independent of the position of the roof section. With the additional degree of freedom, the movable roof section can be moved to intermediate positions together with the roller shade depending on the momentary weather conditions and the need of the vehicle occupants. If, for example, the movable vehicle roof section is a sliding roof, the sliding roof may be in a halfway open position, while the roller shade is in a closed position that is a position in which it covers the sliding roof, the part of the sliding roof remaining in the roof opening can be covered so that the occupants can be partly protected from the sunlight. It is also possible to move the roller shade to an intermediate position while the sliding roof is in an intermediate position.

The pull element for operating the roller shade is preferably a pull bar which extends transverse to the longitudinal direction of the vehicle and which is slidably supported in guide rails extending along the side edges of the movable roof section. In this embodiment, the shade roller is firmly supported on the movable roof section while the pull bar is movable relative to the shade roller along the movable roof section. The position adjustment of the pull bar between a closed and an open position is preferably achieved by means of a drive cable, which is connected to the pull bar for movement thereof between its end positions. The drive cable is preferably supported by the movable roof section as is the electric drive which operates the drive cable so that, except for the electric power supply, the roller shade arrangement is solely associated with the movable roof section.

In a preferred embodiment, a pull bar is slidably supported on the roof section between the shade roller and the mounting element so as to be disposed below the bottom side of the roof section in closely spaced relationship therewith. The shade web extends through the space between the support member and the underside of the roof section so that the shade can follow more closely the curvature of the vehicle roof. Especially when the shade is fully extended and covers the full length of the roof section, it is made sure with the support member that the shade web is held in close proximity to the under side of the roof section. In this way intrusion into the passenger space of the vehicle is minimized. The support member is expediently coupled kinematically with the movable pull bar so that a movement of the pull bar results automatically in a corresponding movement of the support element. Preferably, the support member is so coupled with the pull bar that the support member is moved only after a certain minimum movement distance of the pull bar since minor movement of the pull bar and the shade will have only minor effects which do not detract from the comfort of the vehicle occupants. The delayed movement of the support member preferably occurs by a carrier structure by which the support member is coupled to the pull bar and which may be integrated into the roller shade whereby a space savings arrangement and a uniform appearance of the roller shade is obtained.

Further advantages and suitable embodiments of the invention will become apparent from the following description on the basis of the accompanying drawings.

### BRIEF DESCRIPTION OF THE DRAWINGS

FIG. 1 is a perspective view of a vehicle roof with a movable roof section disposed in a roof opening and including a roller shade at the underside of the movable roof section adjacent the vehicle interior,

FIG. 2 shows a roller shade in an enlarged representation, and

FIG. 3 is a cross-sectional view taken along line III-III of FIG. 2.

### DESCRIPTION OF A PREFERRED EMBODIMENT

In the figures described below the same components are indicated by the same reference numerals.

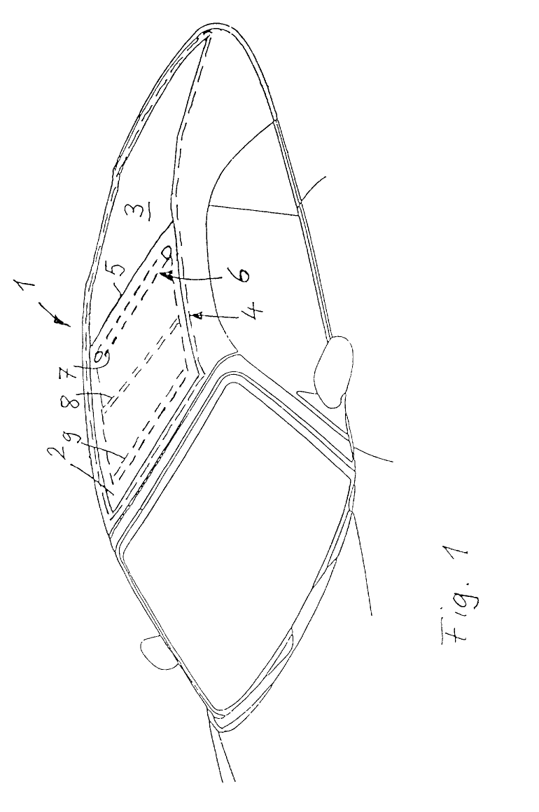

The vehicle roof 1 as shown in FIG. 1 comprises a roof section 2 in the form of a sliding roof and a rear hatchback door 3 which are both disposed in a roof opening of the vehicle and are surrounded by a guide frame 4, which guides and supports the roof section and the hatchback door. The roof section 2 can be moved between a closed position as shown in FIG. 1 and an open position in which the roof section 2 is moved below the hatchback door 3.

The roof section 2 however can assume any intermediate position between the closed and open positions. When in its closed position, the movable roof section 2 adjoins directly the hatchback door 3 along a separation line 5.

At the bottom side of the movable roof section 2 adjacent the vehicle interior, there is provided a roller shade 6, which includes a windup roller 7, which is firmly mounted on the movable roof section 2, a movable support member in the form of a support bar 8 and a mounting element in the form of a pull bar 9, to which one end of the shade web is mounted and which is movable along the guide frame 4 while the other end of the shade web is wound onto, or unwound from, the wind up roller 7. The free end of the shade web is firmly connected to the pull bar 9, which is supported at the underside of the movable roof section 2 so as to be slidable in the direction of the longitudinal vehicle axis. In this way, upon movement of the pull bar 9 from the rear end of the movable roof section 2 toward the front of the vehicle, the shade web is unwound from the wind up roller 7 at the rear end of the roof section 2. Upon movement of the mounting member 9 toward the rear of the vehicle, the shade web is wound onto the wind-up roller 9. The wind-up movement of the shade web is supported by a torsional spring arrangement associated with the wind-up roller.

The wind-up roller 7 and the support member may also be slidably supported whereby different parts of the roof section can be covered by the shade web. In another alternative embodiment, the wind-up roller may be slidably supported whereas the mounting member is firmly attached to the roof section. Furthermore, the wind-up roller may be disposed at the front end of the roof section whereas the mounting member is disposed at the rear end of the roof section.

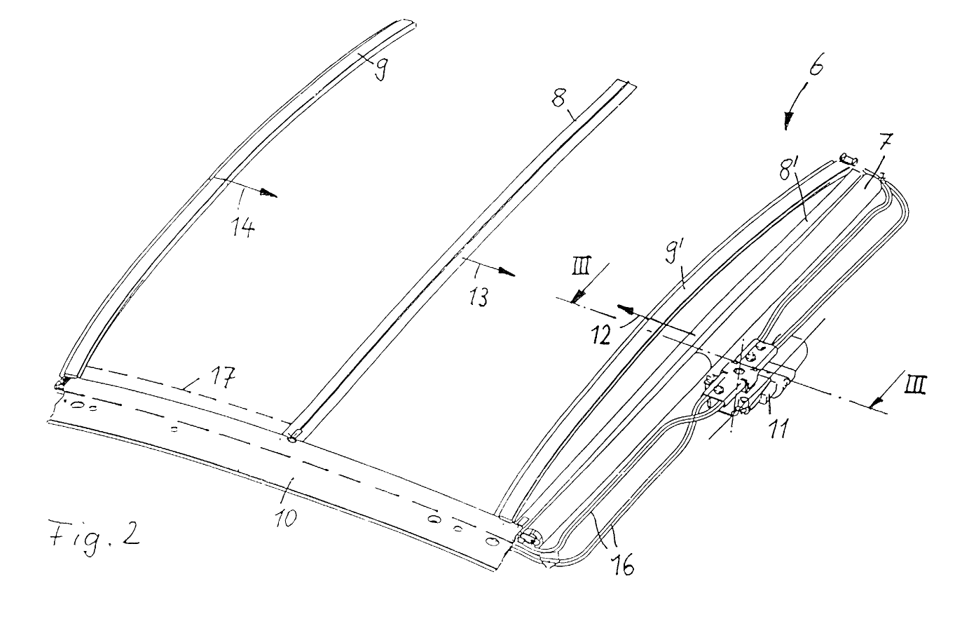

FIG. 2 shows the roller shade arrangement 6 at the bottom side of the roof section 2 in an enlarged representation. Shown herein are the support bar 8 and the pull bar 9 in the extended position in which the movable roof section is totally covered at its underside by the shade web. In its open position in which the shade web is wound up onto the shade roller 7, the transparent roof section is open so that sunlight can enter the vehicle interior unrestricted by the shade. The support bar 8 and the pull bar 9 are shown in FIG. 2 in the closed position of the shade. They are also shown in the open, that is, retracted position of the shade in which they are indicated by numerals 8′ and 9′ respectively. The support bar 8 and the pull bar 9 are both supported in a roof section frame member 10 so as to be slidable in the longitudinal direction of the vehicle. The roof section frame member 10 is mounted to the underside of the roof section. In the retracted (open) position, the support bar 8′ and the pull bar 9′ are disposed directly adjacent the wind-up roller 7. In the extended position of the shade, the pull bar 9 is disposed at the front end of the roof section opposite the wind-up roller 7 and the support bar 8 is disposed about in the middle of the roof section.

For the transfer from the retracted position to the closed position the support bar 8′ and the pull bar 9′ are moved to the front end of the roof section 2 in the direction of the arrow 12. Vice versa, the transfer from the closed position to the retracted position occurs by movement in the opposite direction in accordance with the arrows 13 and 14. The drive for the transfer between the retracted and the closed position is actuated by means of an electric motor 11, which is also mounted firmly onto the roof section 2 and is disposed at the lower side of the roof section 2 behind the wind-up roller 7. The electric motor 11 operates a drive cable 15, which extends through the side portions of the roof section frame 10 and is connected to the pull bar 9. The pull bar 9 can be moved by the drive cable 15 from the retracted position to the closed position and also in the opposite direction. The drive cable 15 extends in the rear area of the roof section through guide tubes 16 to the electric motor 11.

The movement of the support bar 8 is kinematically coupled to the movement of the pull bar 9 by means of a coupling element 17. The coupling element is provided preferably in the form of a carrier structure and is expediently integrated into the shade web. The support bar 8, which has the function to hold the shade web in the shielding position immediately adjacent the underside of the roof section in order to compensate for the curvature of the vehicle roof, is carried along, preferably with a delay, during transition of the shade from the retracted position to the closed position by means of the carrier structure 17 so as to follow when the mounting member 9 has already negotiated part of the distance to its closed position at the front end of the roof section. When the pull bar 9 is fully in its front end position, the support bar 8 is disposed about in the center of the movable roof section. In the opposite direction of movement, that is when the shade is retracted from the closed position to the retracted position the support bar 8 is moved along by the pull bar 9 into a position immediately adjacent the wind-up roller 7.

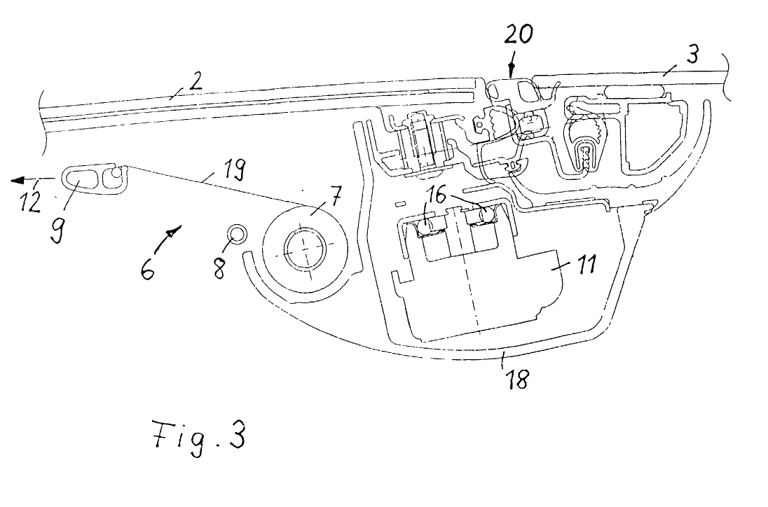

It is apparent from the sectional view according to FIG. 3, that a rear frame portion 18 extends partially below the roller shade arrangement 6, which frame portion 18 is firmly connected to the movable roof section 2. The rear frame portion 18 reinforces the roof section and covers and protects the drive mechanism. The wind-up roller 7 of the roller shade 6 is integrated into the frame portion 18. The roller shade web 19 is moved during a movement into a closed position together with the pull bar 9 and the support bar 8 in the direction of the arrow 12. The frame portion 18 also encloses the drive for the roller shade, especially the electric motor 11 and the guide tubes 16 enclosing the power supply cable 15.

The frame portion 18 furthermore carries a seal structure 20, which is disposed between the rear edge of the roof section 2 and the front edge of the rear hatchback door 3 when the movable roof section 2 is in the closed position.

What is claimed is:

1. A roller shade for a transparent vehicle roof section which is disposed in an opening of a vehicle roof extending over a passenger space and is movable between a closed and an open position, said roller shade including a shade roller rotatably supported on said roof section, a shade web having one end connected to said shade roller and being wound onto said shade roller, a mounting member connected to the other end of said shade web, said shade roller and said mounting member being supported at the underside of said roof section adjacent the passenger space of said vehicle so as to be movable relative to each other for selectively shading said passenger space.

2. A roller shade for a transparent vehicle roof section according to claim 1, wherein said shade roller is mounted on said roof section so as to be stationary and said mounting member is a pull bar which is supported so as to be movable on the underside of said roof element between a closed position spaced from said shade roller, in which said roller shade web is unwound from said shade roller and said transparent roof element is covered, and a retracted position, in which said roller shade web is wound onto said shade roller and the transparent roof element is uncovered.

3. A roller shade according to claim 2, wherein said pull bar extends transverse to the longitudinal axis of said vehicle and said roof section has guide tracks extending at opposite sides thereof in which said pull bar is slidably supported.

4. A roller shade according to claim 3, wherein said pull bar is movable in said guide tracks by a drive cable.

5. A roller shade according to claim 4, wherein an electric motor is mounted on said roof element for actuating said drive cable.

6. A roller shade according to claim 4, wherein a support bar is slidably supported in said guide tracks so as to extend across said roof element in spaced relationship therefrom between said shade roller and said pull bar and said shade web extends through the space between said support bar and said roof element so as to be supported by said support bar.

7. A roller shade according to claim 6, wherein said support bar is kinematically coupled to said pull bar.

8. A roller shade according to claim 7, wherein an engagement structure extends between said pull bar and said support bar.

9. A roller shade according to claim 8, wherein said engagement structure is integrated into said shade web.

10. A roller shade according to claim 8, wherein said engagement structure includes a kinematic idling arrangement wherein, upon movement of said pull bar out of its position adjacent said shade roller to the closed position said support bar follows said pull bar only with a certain delay.

11. A roller shade according to claim 1, wherein said shade roller is mounted to said roof section at the rear end thereof remote from the front of the vehicle and the mounting member is disposed ahead of said shade roller.
